(19) United States
(12) Patent Application Publication
(10) Pub. No.: US 2011/0178892 A1
(43) Pub. Date: Jul. 21, 2011

(54) Online Offer System

(75) Inventors: Paul J. Fletcher, Mission Viejo, CA (US); Garry Heath, Coto De Caza, CA (US)

(73) Assignee: BEST BUY ENTERPRISE SERVICES, INC., Richfield, MN (US)

(21) Appl. No.: 13/012,708

(22) Filed: Jan. 24, 2011

Related U.S. Application Data
(63) Continuation of application No. 11/002,930, filed on Dec. 1, 2004, now abandoned.

(51) Int. Cl. G06Q 30/00

(52) U.S. Cl. 705/26.3; 705/26.1

(57) ABSTRACT

An online offer system is directed toward methods and devices that allow a seller to enter information about the attributes of a non-fungible good based on parameter values provided on a database. In response, an automated purchaser issues a firm offer to purchase the good at a set price.

This application is continuation of U.S. patent application Ser. No. 11/002930 filed on Dec. 1, 2004 and is incorporated by reference herein in its entirety.

### FIELD OF THE INVENTION

The field of the invention is online business.

### BACKGROUND OF THE INVENTION

From a buyer's perspective, online purchases have their advantages and their disadvantages. A significant disadvantage is the inability of the buyer to physically examine the article being purchased. Lack of physical examination would seem to lead to unsatisfied buyers, increased instances of return, and the abandonment of online purchases. Despite the lack of physical examination of products, online purchasing has become increasingly popular. Perhaps one reason that buyers continue to buy online is that they are able to view photos of the products in order to make an assessment about quality. In addition to viewing photos, buyers can often review text descriptions about the products before deciding whether to buy.

In the case of an automated site unseen purchase, however, there is no prior assessment of photos or textual information by the buyer. Automated buyers rely on the reputation of either the product or the seller to mitigate the lack of any kind of prior assessment. For instance, an automated buyer of a new Compaq™ computer generally knows the quality of the computer based on the reputation of Compaq™. On the other hand, an automated buyer may buy a computer of unknown quality from Circuit City™ based on the reputation of Circuit City™ Many online sites, especially those that purchase automatically, rely on the reputation of the seller, the product, or both.

While the quality of used or non-fungible goods is far more difficult to ascertain without photos or textual information, sometimes the quality of the good can be determined based on the use of a uniform rating system. Coins and diamonds are good examples of used products that can have a known quality by virtue of a uniform rating system. For most used goods, however, there is not a uniform rating system and therefore automated purchase of these goods has not yet been undertaken.

Thus, there is a need for systems and methods that enable the automated purchase of used and non-fungible goods.

### SUMMARY OF THE INVENTION

The present invention provides methods of conducting on-line business by providing a database that can be accessed by a seller to determine a set price for a particular non-fungible good. An automated purchaser then issues a firm offer to purchase the non-fungible good at the set price.

In another aspect, methods of doing business comprise offering fixed price quotes for purchase of non-fungible used goods, receiving the goods; and reselling the goods on an on-line commerce site.

In yet a further aspect, a deal-making system is programmed to provide a set price for a non-fungible good based on parameter/values selected by a seller and to issue a firm offer for the non-fungible good at the set price.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a schematic of a method of conducting on-line business.

FIG. 2 is a schematic of a method of doing business.

FIG. 3 is a schematic of a parameter/value entry screen.

FIG. 4 is a schematic of a flow of non-fungible goods and funds.

### DETAILED DESCRIPTION

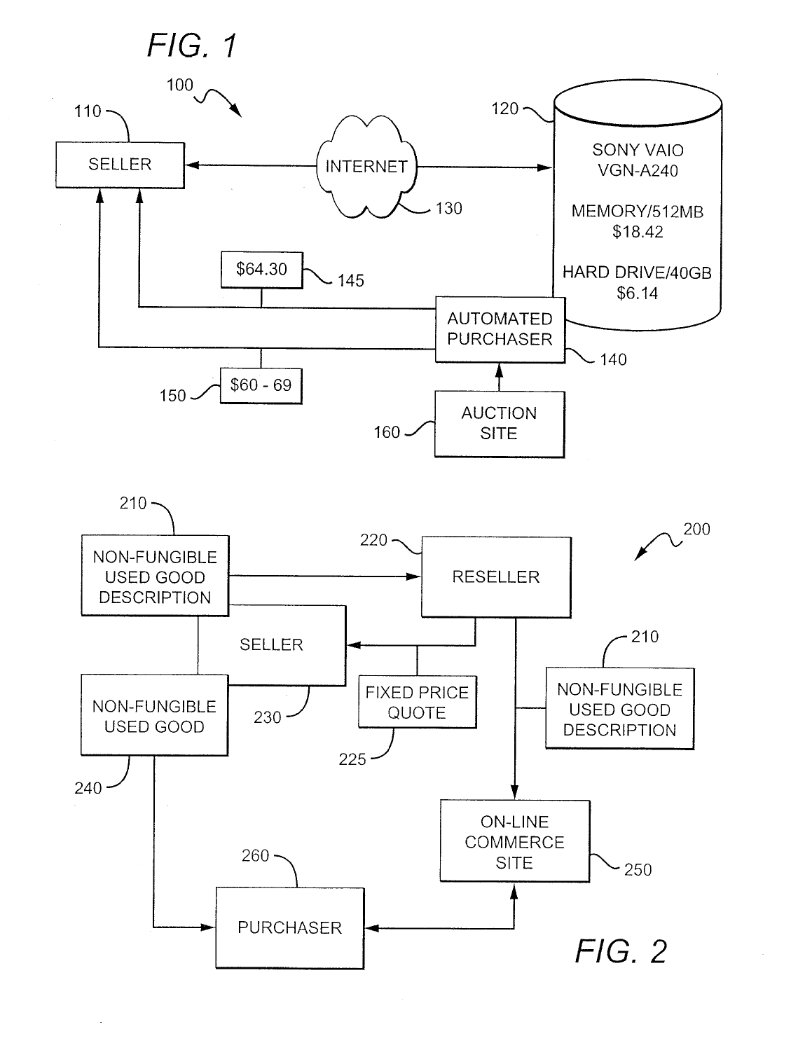

Referring first to FIG. 1, a method of conducting on-line business 100 generally comprises a seller 110 accessing data on a database 120 over the Internet 130 in order to determine a set price 145 offered by an automated purchaser 140.

Seller 110 is an entity that desires to sell a non-fungible good. “Fungible” basically means freely replaceable in satisfying an obligation. Thus, a non-fungible good is one that is not freely replaceable in satisfying an obligation. Generally, the reason that a good is not freely replaceable is because it has a reduced value due to its physical condition. Accordingly, a non-fungible good is not: a new good in new condition; a used good that has a standard price by virtue of a standardized rating system (e.g. a rated coin, diamond, or collectible); and a share of stock or other good where the value is not in the good itself. Some examples of a non-fungible good 240 (FIG. 2) are: used cameras, used PDAs, used cell phones, used cars, and antiques.

A seller can be a company, an individual, or other entity including a partnership, joint venture, and so on. Seller 110 accesses database 120 through the Internet 130 and an interface, which provides access to the data on the database 120. It is contemplated that a seller 110 can be led to the database after having clicked on a hyperlink in an auction site. In a preferred class of embodiments, a seller uses parameter and associated values to enter information concerning the good being sold or a class within which the good being sold falls. Contemplated classes can be: electronics including computers, personal digital assistants (PDA), printers, cameras, cell phones, and camcorders; sporting equipment including ping pong tables, footballs, and shot puts; musical instruments including clarinets, drums, and guitars, and other classes including motorcycles, apparel, and furniture. Although preferred embodiments include communications that traverse the Internet, it should be understood that the Internet is not a requirement so long as there is a viable interface between the seller and the database.

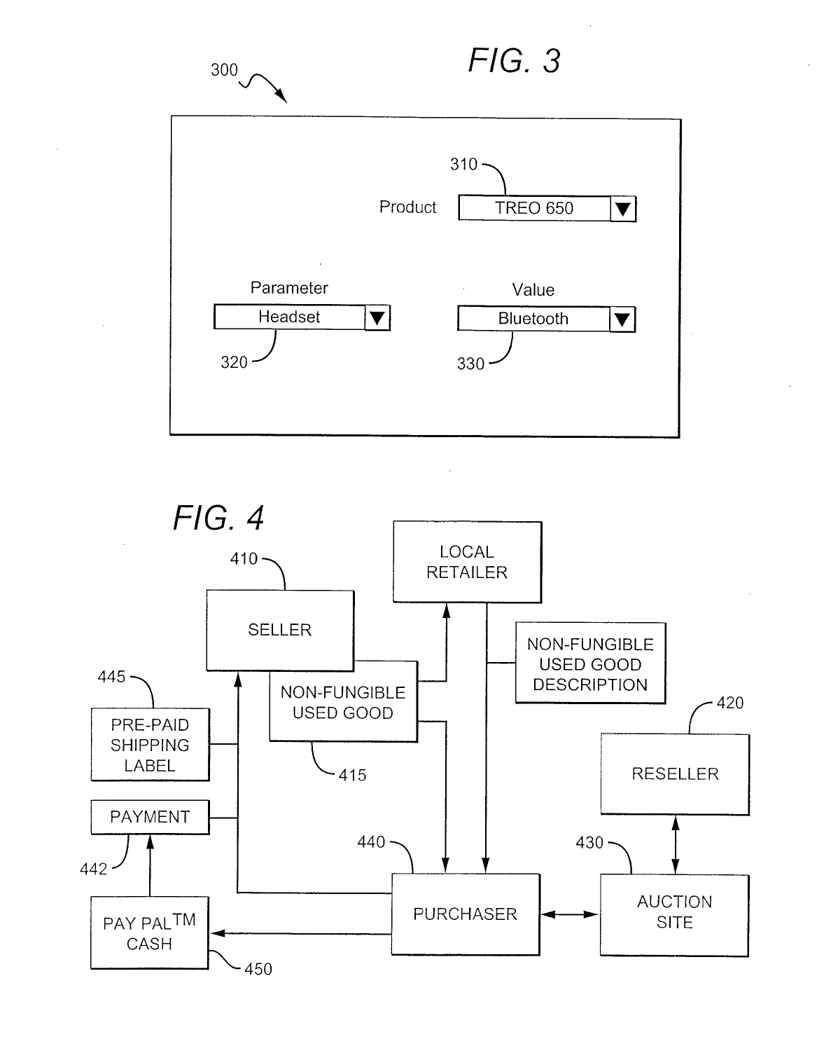

Database 120 comprises fields for: description of the type of good (e.g. model number) or description of the class of goods (e.g. computers), parameters (e.g. memory size, hard drive size, sound card . . . ), associated values for the parameters (e.g. 512 MB, 256 MB, 40 GB, Sound Blaster™ . . . ), and associated prices that are derived from the parameter/value pairs (e.g. memory size/512 MB, $18.42). In addition to the fields mentioned, the database or databases can also retain historical fields having to do with return on investment such as the set price and the sales price to third parties. Database 120 may also retain historical parameter value pairs so that they can be displayed to sellers in a drop down menu. This concept will be discussed in more detail with reference to FIG. 3.

Database 120 is housed on the server for the automated purchaser 140. One of skill in the art will recognize, however, that data can be stored almost anywhere including remote locations and servers of other parties so long as it is accessible to the seller.

Automated purchaser 140 maintains control of database 120 although such control can be delegated to other entities in less preferred embodiments. An automated purchaser is envisaged to be an entity that has a program or series of instructions that display parameter values for a seller and accept the seller's input. The automated purchaser then automatically determines a set price for the seller's good based on the class of the good, the parameter/values, and the prices for the associated parameter/values. For example, in FIG. 1, the seller has entered a class of good as “Sony™ Vaio™ VGN-A240, a memory size as “512 MB”, and a hard drive size as “40 GB”. It can be observed that the price associated with the parameter “Memory” and the value “512 MB” is $18.42. Additionally, the price associated with the parameter “Hard Drive” and value “40 GB” is $6.14. Automated purchaser 140 uses these prices ($18.42 and $6.14) to come up with the set price of $64.30 for the Sony™ Vaio™ VGN-A240.

Set price 145 is derived from adding the prices associated with the parameter/values and other factors such as a product's age and demand for the product. In any case, an algorithm is executed in order to determine the set price. The set price 145 is then issued to the seller 110 as a firm offer. The words “firm offer” and “fixed price quote” are intended to create a contractually binding offer if accepted. Thus, a seller can indicate his acceptance of a set price thereby creating a binding contract for the sale of the good at the selling price. Additional terms required to create an enforceable contract will be agreed upon by the parties either in advance or at the time of acceptance by the seller. Such terms can be included in an end user license agreement that the user must accept before accessing the data.

A further aspect to the methods described above includes the automated purchaser 140 communicating with an auction site 160 to establish an expected range 150 within which the seller is expected to be able to sell the good himself The expected range can be derived from data provided by one or more auction sites or the expected range can be based on data maintained by the automated purchaser or another entity such as a consumer bureau.

FIG. 2 depicts a method of doing business 200 in which a fixed price quote 225 is offered for purchase of a non-fungible used good 240.

In practice, methods of doing business preferably include a non-fungible goods description 210 being communicated to an entity such as the reseller 220 shown in FIG. 2. In response, the reseller 220 communicates at least one fixed price quote 225 to the seller 230. Preferably, fixed price quotes will be communicated in real time. If the seller accepts the fixed price quote 225, a binding contract is created for the sale of the non-fungible used good 240 to the reseller 220. Upon acceptance of the fixed price quote 225, the reseller 220 communicates with an on-line commerce site 250 such as an auction site (e.g. e-bay™) in order to sell the non-fungible used good 240 over the on-line commerce site 250. A significant advantage in the sale of the good is to have a reseller use its own trademark (and associated good will) when selling the good through the auction site. Thus, instead of an unknown seller, there is now a known seller.

FIG. 3 shows an entry screen 300 for entry of product description information. It should be appreciated that there are drop down menus for the product type 310, the parameter 320 and the value 330. In preferred embodiments, a parameter is a description of an option, attribute, or characteristic that is associated with the class of product being sold. So, for example, an appropriate option for a Treo™ personal digital assistant is “headset”. Another may be “memory size” and so on. A value associated with “headset” can be “Bluetooth™ since the headset can utilize a Bluetooth™ protocol. An appropriate parameter can also be model number which likely will include the name of the manufacturer or OEM. Another option for “headset” can be “wired” an so on. One of skill in the art will recognize that by allowing users to select parameters and values from a drop down window, duplication of data is reduced. If a desired parameter or value is not displayed for selection, however, the parameter or value will be accepted and displayed for selection thereafter. For instance, if a user desires to enter a “memory size” of “1024 MB” and that value does not exist in the drop down menu of values, then the value “1024 MB” will be accepted and thereafter listed in the drop down menu associated with “memory size”.

FIG. 4 depicts a flow of funds and non-fungible goods 400. Once sold, a non-fungible used good 415 is drop shipped directly to the end purchaser 440. In other embodiments, the good can be shipped to the reseller or another entity for quality control or resetting (e.g. erasing data or reloading an operating system) before being shipped to the end purchaser. It should also be pointed out that a prepaid shipping label 445 can be sent by the end purchaser 440 or the reseller 420 to the party shipping the good. Expanding on that concept, a seller 410 can deliver the goods to a local (to the seller) retailer other than a shipping company. The local retailer acts on behalf of the purchaser of the good.

Another aspect includes payment to the seller of the good. In some embodiments, payment will come from the reseller but in other embodiments, payment is issued by the end purchaser directly to the seller without any payment being made by the reseller. Preferably, payment 442 will be made in the form of an on-line negotiable payment such as PayPal™ cash 450 or store credit.

Deal making systems according to the inventive subject matter include a microprocessor programmed to: provide a set price based on parameter values selected by a seller and to issue a firm offer for a non-fungible good at the set price. The microprocessor can be further programmed to receive an acceptance of the firm offer. Preferably, a firm offer will be issued, and/or an acceptance will be received, without any manual intervention.

Thus, specific embodiments and applications of an on-line offer system have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A method for an entity to purchase a non-fungible used item from a seller, comprising:
providing a database that associates fixed purchase prices with values of parameters relating to specific classes of non-fungible used goods;
entering into an agreement with the seller to purchase the item according to a corresponding one of the fixed prices stated in the database; and
arranging for receipt and inspection of the item, and then following the inspection, arranging for payment of the fixed price to the seller pursuant to the agreement even where the item falls outside an estimate of what the entity could re-sell the item in an on-line auction.

2. The method of claim 1, further comprising the reseller providing to the seller an expected range within which the seller is expected to be able to sell the good to an entity other than the reseller.

3. The method of claim 2, further comprising calculating the expected range based on information provided by an auction site.

4. The method of claim 1, further comprising a local retailer acting on behalf of the reseller to receive the item.

5. The method of claim 1, further comprising the entity using its own trademark and associated good will to resell the item through an auction site.
